(19) United States
(12) Patent Application Publication
(10) Pub. No.: US 2026/0046188 A1
(43) Pub. Date: Feb. 12, 2026

(54) TRANSMISSION SCHEME FOR DIFFERENT WAVEFORMS USING PARTIAL LOADING TO ENHANCE RELIABILITY

(71) Applicant: INDIAN INSTITUTE OF TECHNOLOGY KHARAGPUR, Kharagpur (IN)

(72) Inventors: B. V. Sudhakar Reddy, Kharagpur (IN); Chaithanya Velampalli, Kharagpur (IN); Suvra Sekhar Das, Kharagpur (IN)

(21) Appl. No.: 18/966,282

(22) Filed: Dec. 3, 2024

(30) Foreign Application Priority Data
Aug. 6, 2024 (IN) 202431059501

(51) Int. Cl. H04L 27/34; H04L 27/36

(52) U.S. Cl. CPC H04L 27/3405; H04L 27/36

(57) ABSTRACT

A wireless communication system for enhanced reliability of wireless communication and reducing peak power in wireless data transmission across different waveforms comprising transmitter modules coupled to waveform modulators including waveform two-dimensional resource or data grids representative of a signal processing domain for transmitting data bit bearing symbols across varied waveforms under controlled sparsely/partially loading of fewer modulated data symbols of the available grid points of a larger two-dimensional resource or data grid for transmission as spaced fewer data symbols with loading zero symbols at remaining empty grid points. The modulated data symbols under controlled sparsely/partially loading including said fewer modulated data symbols being allocated in the resource or data grid and distanced there between based on a factor for partial loading and full number of symbols accommodable in the resource or data grid to reduce cross interference amongst symbols and minimize error rate.

### FIELD OF THE INVENTION

The present invention relates to a wireless communication technique suitable for high sensitivity and emergency applications. More specifically, the present invention is directed to provide an improved wireless communication system and method with transmission mechanistic analytics to improve reliability of transmission and peak power by reducing cross interference between data symbols caused by doubly dispersive wireless channels. Highly reliable and low peak powered data transmission in the present wireless communication system and method is can be provided through certain waveforms like OTFS, OTSM, OFDM, and single carrier. These waveforms form a two-dimensional data grid representing a particular signal processing domain. For OTFS, the data grid represents the delay-Doppler domain; for OFDM, the time-frequency domain; for OTSM, the delay-sequency domain; and for single carrier, the delay-time domain. The data grids, usually filled with data symbols at all grid points for transmission, is now transmitted with fewer data symbols. These symbols are spaced apart by a few grid points, with zeros filled in the gaps. This reduces the amount of inter-Doppler and multipath interference, which results from doubly dispersive channels. Consequently, a high SNR gain can be obtained at reception for a given error performance metric. The amount of SNR gain depends on the selected waveform (OTFS, OTSM, OFDM, or single carrier) for the transmission.

### BACKGROUND ART

A precoding based on channel state information is present for OTFS to improve reliability. However, for this the transmitter is required to know the channel state information or estimation need to be performed at the transmitter.

On this reference is invited to the following prior arts under Table 1 below:

| No. | Name of the Work | Prior Art Problems |
|---|---|---|
| [1] | R. Hadani et al., “Orthogonal Time | A new waveform OTFS is |
| | Frequency Space Modulation,” 2017 | introduced which exhibits |
| | IEEE Wireless Communications and | resilience under high |
| | Networking Conference (WCNC), | mobility conditions. No |
| | San Francisco, CA, USA, 2017, pp. | further enhancements are |
| | 1-6, doi: 10.1109/ | given to reduce the error |
| | WCNC.2017.7925924 | rate and increase reliability. |
| [2] | J. Sun, Z. Wang and Q. Huang, | A precoding based OTFS |
| | “A Closed-Form Minimum BER | transmission is given to |
| | Precoder for Orthogonal Time | reduce the error rate. |
| | Frequency Space Systems,” in | However, the design of |
| | IEEE Communications Letters, | precoding matrix requires |
| | vol. 26, no. 8, pp. 1898-1902, | channel state information at |
| | August 2022. | the transmitter which |
| | | requires high feedback |
| | | overhead. |
| [3] | C. Liu, S. Li, W. Yuan, X. Liu and | A precoding matrix for |
| | D. W. K. Ng, “Predictive Precoder | OTFS transmission is |
| | Design for OTFS-Enabled URLLC: | designed using historical |
| | A Deep Learning Approach,” in | channels and Deep learning |
| | IEEE Journal on Selected Areas in | algorithms to improve the |
| | Communications, vol. 41, no. 7, | reliability However for |
| | pp. 2245-2260, July 2023 | training deep learning |
| | | neural network and tracking |
| | | the channel time variations |
| | | at the transmitter increase |
| | | the latency. |

In Ref. [1] above of the patent abstract, a new waveform OTFS is proposed however, the measures for improving reliability is not given. In Ref. [2], a precoding for OTFS transmission is proposed with ideal channel state information (CSI) at the transmitter. In Ref. [3] also a precoding for OTFS transmission is proposed which require transmitter to predict channel state information at the transmitter.

Hence, in spite of the above known state of the art there is still a need in the art of wireless communication systems with enhanced reliability that would be made possible by partial loading of certain waveforms like OTFS, OTSM, OFDM, and single carrier in two-dimensional resource grids that would not require CSI at transmitter and help reduce cross interference among QAM symbols and reduce latency.

### OBJECTS OF THE INVENTION

It is thus the basic object of the present invention to provide for wireless communication system and method embedded with transmission mechanistic analytics that would facilitate reliability of data transmission by reducing cross interference between data symbols caused by doubly dispersive wireless channels and would also reduce latency in designing precoding matrices.

It is another object of the present invention to provide for said wireless communication system and method with embedded transmission analytics that would support high speed scenarios and high reliability requirements.

It is yet another object of the present invention to provide for said wireless communication system and method with embedded transmission analytics that would reduce power consumption for battery driven devices for their uplink transmission due to low peak power waveform generation.

### SUMMARY OF THE INVENTION

Thus, according to the basic aspect of the present invention there is provided a wireless communication system for enhanced reliability of wireless communication and reducing peak power in wireless data transmission across different waveforms comprising
transmitter modules coupled to waveform modulators including waveform two-dimensional resource or data grids representative of a signal processing domain for transmitting data bit bearing symbols across varied waveforms under controlled sparsely/partially loading of fewer modulated data symbols of the available grid points of a larger two-dimensional resource or data grid for transmission as spaced fewer data symbols with loading zero symbols at remaining empty grid points,
said modulated data symbols under controlled sparsely/partially loading including said fewer modulated data symbols being allocated in the resource or data grid and distanced there between based on a factor for partial loading and full number of symbols accommodable in the resource or data grid to reduce cross interference amongst symbols and minimize error rate;
cooperative receiver module corresponding to receive all loaded grid points and including demodulator to selectively demodulate only those select grid points carrying said fewer modulated data symbols loaded during transmission by said transmitter module, thereby enabling reliable data transmission with several dB signal to noise ratio advantage free of any need of Channel State Information (CSI) analytics at the transmitter.

In the above system, said transmitter module bear processor domains that include data symbol-based signal generating domain, the two-dimensional resource or data grid formation domain, modulated signal waveform based sparse symbol loading domain for loading transformed signal, transformed signal signaling domain;
said modulators are based on Quadrature Amplitude Modulation (QAM) or Phase Shift Keying (PSK) modulation of order ‘M’ for transmitting and loading said QAM based symbols or PSK symbols onto said resource or data grid.

In the above system, said data grid includes a processor for creating virtual two dimensional data grid from available resource elements for transmitting OFDM (orthogonal frequency division multiplexing) waveforms while integrating the partial load method with existing OFDM-based systems or creating a straightforward two dimensional data grid of resource elements, said data grid being characterized by a delay dimension and a Doppler dimension for processing OTFS (orthogonal time frequency space) waveform, delay and Sequency for OTSM (orthogonal time sequence multiplexing) waveform, and delay-time for single carrier (SC) waveforms.

In the above system, said resource grid includes size M×N for accommodating the full MN number of symbols the resource or data grid being arranged into an M×N matrix X, which matrix X matches the dimensions of the resource grid with the row-column position of each QAM symbol in X representing a grid point in the signaling domain including delay-Doppler (de-Do) for OTFS, time-frequency (TF) for OFDM, delay-sequency for OTSM, and delay-time for SC transmission.

In the above system, for transmission at bandwidth B the delay bin resolution (Δτ), Doppler bin resolution (Δv), time symbol duration (T), and subcarrier spacing (Δf) are related to each other as,

$$Δ τ = \frac{1}{B} , Δ v = \frac{1}{MN Δ τ} , T = M Δ τ , Δ f = \frac{1}{T} . \qquad ( 1 )$$

wherein signal generation with the data symbols present in matrix X, for the waveforms OTFS, OFDM, OTSM, and single carrier (SC) is computed in an unified manner using matrices Q and P listed in below Table for said different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

where

$${F}_{N}^{H}$$

is an Inverse Discrete Fourier Transform (IDFT) matrix of order W_{N} is a Walsh Hadamard Transform (WHT) matrix of order N, and I_{N} is an identity matrix of order N, and
which signal generation with the data symbols present in matrix X unified under said P and Q matrices for straight forward two-dimensional data grid are computed as

$$s = vec ( QXP ) , \qquad ( 2 )$$

$$= ( P ⊗ Q ) x , \qquad ( 3 )$$

where

$$s = {\{ s [ n ] \}}_{n = 0}^{MN - 1}$$

is a discrete time sginal, x∈ [symbol] ^{MN×1}=vec(X) and a single cyclic prefix (CP) of length I_{cp} is sufficient to accommodate channel delay spread that is included in s before transmission.

In the above system, the transmitter module partially load only I<M N number of QAM symbols of full (M N) number of accommodable symbols whereby I and M N are related by the partial loading factor ‘α’ which is being computed by the transmitter module as

$$I = α MN \qquad ( 4 )$$

and if d=[d[0], d[1], . . . , d[i], . . . , d[I−1]]^{T} is denoted as symbol vectors for transmission based on their partially/sparsely loading onto M×N type matrix named as X^{˜} partially loaded matrix with the vectors loaded therein in a systematic form with distance β₁ maintained between two consecutive symbols along row dimension and distance β₂ maintained along the columns with Zero symbols being filled in other positions of said X^{˜ matrix.}

In the above system, the sparsely loaded X^{˜} matrix when M and N are divisible by β₁ and β₂ respectively, then β₁ and β₂ are related to ‘α’ by the equation

$${β}_{1} {β}_{2} = \frac{1}{α} \qquad ( 5 )$$

In the above system, the sparsely loaded X″ matrix where M and N are not divisible by β₁ and β₂ respectively, a reduced grid M_{new}×N_{new} is instead involved for loading symbols where M_{new}≤M becomes divisible by β₁ and N_{new}≤N becomes divisible by β₂, and elements x\tilde(l, k) of X\tilde for l=0, 1, . . . , M−1 and k=0, 1, . . . , N−1 is expressed as

$$\tilde{x} ( l , k ) = \{ \begin{matrix}d [ i ] & if l = {( i )}_{\text{?}} {β}_{1} and k = ⌊ \frac{\text{?}}{M} ⌋ {β}_{2} \\ 0 & Otherwise\end{matrix} \qquad ( 6 )$$

$$\text{?} \text{indicates text missing or illegible when filed}$$

In the above system, corresponding to said signal generation with said data symbols present in matrix X unified under said P and Q matrices for different waveforms and computed as in Eq. (3),
the corresponding transmitting signal with partial loading is expressed as

$$\tilde{s} = ( P ⊗ Q ) \tilde{x} , \qquad ( 7 )$$

where x^{˜}=vec(X^{˜}) said x^{˜} is also computed in terms of MN×I matrix J and d represented as

$$\tilde{x} = Jd . \qquad ( 8 )$$

where the elements j(n, i) of J, for n=0, 1, . . . , MN−1 and i=0, 1, . . . , I−1, are given as

$$j ( n , i ) = \{ \begin{matrix}1 & if n = {( i )}_{\text{?}} {β}_{1} + ⌊ \frac{\text{?}}{M} ⌋ {β}_{2} M \\ 0 & Otherwise .\end{matrix} \qquad ( 9 )$$

$$\text{?} \text{indicates text missing or illegible when filed}$$

wherein from equation (9), since J matrix is non-square and its column vectors are orthogonal to each other, it satisfies the semi-orthogonality condition as per the following computational relation

$${J}^{T} J = {I}_{\text{?}} . \qquad ( 10 )$$

$$\text{?} \text{indicates text missing or illegible when filed}$$

In the above system, the partially loaded matrix based transmitting signal after passing through a wireless channel, the received signal at receiver after removal of said cyclic prefix (CP) and transformation to the signaling domain is expressed as

$$\tilde{y} = H \tilde{x} + w , \qquad ( 11 )$$

where H is the channel matrix in transforming domain with a size of MN×MN, and w is the AWGN noise in the transforming domain whereby computing in relation to said eq. (8) the computation under Eq. (11) is re-computed to

$$\tilde{y} = HJd + w . \qquad ( 12 )$$

where estimate of ‘d’ is then obtained by performing MMSE equalization as:

$$\hat{d} = {G}^{H} \tilde{y} , \qquad ( 13 )$$

$$= {G}^{H} HJd + {G}^{H} w \qquad ( 14 )$$

where G∈C^{MN×I}

$$G = ( HJ ) {( {( HJ )}^{H} ( HJ ) + {σ}^{2} {I}_{i} )}^{- 1} . \qquad ( 15 )$$

whereby order of matrix under inversion in computation (15) is I which is the number of symbols being transmitted for receiving by said cooperative receiver module.

In the above system uncoded bit error rate (BER) comparison with different β₁ and β₂ for OTFS and single carrier (SC) based on the present transmission system provides in 3GPP channel signal propagation under grid parameters of M=512 and N=16 which in consideration of full load having distance parameters β₁=1 and β₂=1, and for OTFS's partial loading under distance parameters β₁=2 and β₂=2, while for single carrier (SC) propagation having β₁=4 and β₂=1, whereby in both said partial loading scenarios loading factor α=¼ both said single carrier (SC) and OTFS benefit from partial loading providing an SNR (signal-to-noise ratio) gain of nearly 4.5 dB at a BER of 10⁻² with OTFS provides an extra 0.5 dB SNR gain compared to the single carrier (SC).

In the above system, the sparsely loading limited number of data symbols onto a larger resource grid, said QAM symbols are separated by a distance of β₁ symbols along the delay dimension and/or across the Doppler dimension for OTFS and the Sequency dimension for OTSM with a distance of β₂ symbol, and wherein in single carrier (SC) based waveforms symbols are separated only along the delay dimension by a distance of β₁ symbols while β₂=1 and zero symbols are loaded in the other points of the grid.

In the above system, distance parameters β₁ and β₂ are so selected to sufficiently accommodate the delay spread of the wireless communicative channels, and β₂ is selected to sufficiently accommodate the Doppler spread of the channels, and alternatively in the range of 1 to M−1 for β₁ and 1 to N−1 for β₂ respectively.

In the above system for selected values for β₁ and β₂ if the grid parameters M and/or N are not divisible by β₁ and/or β₂ respectively, a reduced grid M_{new}≤M and N_{new}≤N are processed, for which β₁ and β₂ divide M_{new} and N_{new}, respectively and Zero symbols are loaded for the points between M_{new} and M and N_{new} and N.

In the above system, sparsely loaded symbols on the resource grid are transmitted based on modulation by said waveform modulators that processes by computing through inverse ZAK transform for OTFS or inverse discrete symplectic Fourier transform (IDSFT) or their alternative forms, followed by OFDM modulation.

In the above system, the waveform modulators instead of processing by inverse discrete Fourier transform operation in inverse ZAK and IDSFT for the virtual data grid or their alternatives, the Walsh-Hadamard transform is operation is involved to transmit sparsely loaded data symbols on the resource grid for OTSM.

In the above system, for single carrier waveform (SC), the loaded data symbols and zero symbols on the resource grid are directly transmitted serially, column by column.

In the above system, peak power of the transmitted waveform can be reduced and help minimize the nonlinear effects of high-power amplifiers for suitable end applications in 6G applications for ultra-reliable and low latency communication (uRLLC) applications including communications from low-power and low-cost internet of things (IoT) devices.

According to another aspect in the present invention there is provided a method for wireless communication with enhanced reliability and reducing peak power in wireless data transmission across different waveforms comprising
modulating transmitting data bit bearing symbols across varied waveforms to produce modulated data symbols by waveform modulators;
sparsely/partially loading the modulated data symbols in available grid points of a larger two-dimensional resource or data grid for transmission by transmitter module;
fixing selective distances between the modulated data symbols while allocating in the resource or data grid based on a factor for partial loading and full number of symbols accommodable in the resource or data grid to reduce cross interference amongst symbols and minimize error rate; and
loading zero symbols at remaining empty grid points.

In the above method, the modulated data symbols are obtained with Quadrature Amplitude Modulation (QAM) or Phase Shift Keying (PSK) modulation.

In the above method, fixing selective distances between the modulated data symbols while allocating in the resource or data grid includes
involving said resource grid includes size M×N for accommodating full MN number of symbols in the resource or data grid arranged into an M×N matrix X;
partially loading I number of points of the full (M N) number of accommodable symbols with modulated symbols where whereby I and M N are related by the partial loading factor ‘α’ as I=αM N;
miniating a distance β₁ between two consecutive loaded symbols along row dimension and a distance β₂ along columns with zero symbols being filled in other points, whereby the β₁ and β₂ are related to ‘α’ as β₁·⊕₂=1/α when M and N are divisible by β₁ and β₂ respectively and M and N are not divisible by β₁ and β₂ respectively, a reduced grid M_{new}×N_{new} is involved for loading symbols where M_{new}≤M becomes divisible by 31 and N_{new}≤N becomes divisible by β₂.

In the above method, parameters 31 and 32 are so selected to sufficiently accommodate the delay spread of the wireless communicative channels, and β₂ is selected to sufficiently accommodate the Doppler spread of the channels, and alternatively in the range of 1 to M−1 for β₁ and 1 to N−1 for β₂ respectively.

### BRIEF DESCRIPTION OF FIGURES

FIG. 1: illustrates partial loading of data symbols with distance parameters β₁ and β₂;

FIG. 2: illustrates data grid with partial loading for single carrier waveform;

FIG. 3: illustrates data grid transmission block.

FIG. 4: illustrates uncoded BER comparison with different β₁ and β₂ for OTFS and single carrier;

FIG. 5: illustrates peak power distributions of OTFS for different partial loading factors.

### DETAILED DESCRIPTION OF THE INVENTION

As discussed hereinbefore, the present invention provides for a wireless communication system and method suitable for high sensitivity and emergency applications in wireless communication embedded with transmission mechanistic analytics to improve reliability of transmission and peak power by reducing cross interference between data symbols caused by doubly dispersive wireless channels. Here, high-sensitivity and emergency applications includes all Ultra-Reliable Low-Latency Communications (URLLC) in 6G such as autonomous vehicles, remote surgery, and industrial automation. These services demand extremely high reliability, typically 99.9999%, which is directly linked to the frame error rate (FER) as (1−FER)×100%.

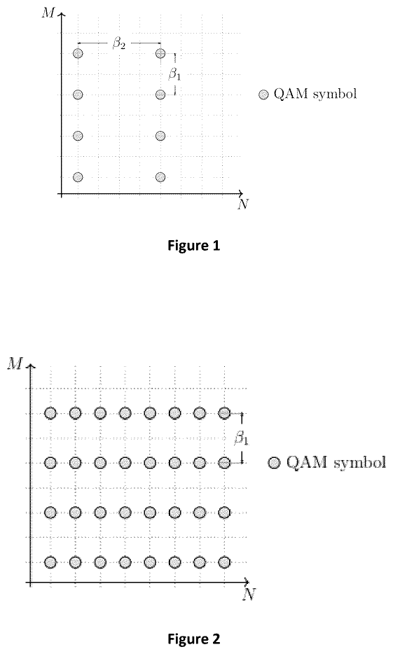

According to embodiments of the present invention a system and method of wireless transmission using waveforms OTFS, OTSM, OFDM and single carrier is provided that improves reliability and reduces peak power. This method reduces cross interference between data symbols caused by doubly dispersive wireless channels. It sparsely loads relatively fewer data symbols compared to the total available grid points for transmission, resulting in a loss of spectral efficiency. The data symbols are placed apart both vertically and horizontally on the grid to avoid dispersion due to Doppler effects and multipaths. The FIG. 1 demonstrates the partial loading for the grid size M×N=8×8 with a distance separation in vertical and horizontal direction as 2 and 4 respectively.

After loading the data symbols onto the grid as shown in the FIG. 1, the data grid will be modulated to generate one of the waveforms from OTFS, OTSM, OFDM, and single carrier. This modulation is referred as waveform modulation.

### Uniqueness of the Present Invention

System and Method to improve reliability.
Control on the inter Doppler interference and inter delay or multi path interference by adjusting the distance values along horizontal and vertical direction on the grid;
The system allows for reliable data transmission without the need for Channel State Information (CSI) at the transmitter.
The error rates can be decreased by increasing the distance between the Quadrature Amplitude Modulation (QAM) symbols along the delay or Doppler dimension of the resource grid.
The peak power of the transmitted waveform can be reduced and help minimize the nonlinear effects of high power amplifiers.
Enhance reliability using partial loading in OTFS, OTSM, OFDM, and single Carrier preferably based on the insertion of zeros between the QAM symbols in a two-dimensional resource grid that helps reduce cross-interference among QAM symbols.

Merits of the present system: The present system is free of the requirement of channel state information or complex algorithms at the transmitter as a part of the embedded analytics, which would otherwise increase latency in designing the precoding matrix.

### Advantages of the Present Invention

It supports high speed scenarios and high reliability requirements
Power consumption for battery driven devices will be reduced for their uplink transmission due to low peak power waveform generation

The partial load based transmission is tested for 3GPP channel model for NLOS and urban macro (UMA) with waveforms OTFS and single carrier. The grid parameters are M×N=512×16 and Doppler spread is about 1.8 KHz.

The present invention improves the reliability of reception for high sensitivity and emergency applications in wireless communication by providing a transmission mechanism. It also lowers the peak power requirement for high-power amplifiers (HPA) in the transmitter. This allows internet of things (IoT) reduced capability devices to be used in cases that require high reliability. It uses orthogonal time frequency space (OTFS), orthogonal time sequency multiplexing (OTSM), and single carrier waveforms for transmission. These provide higher channel diversity than the orthogonal frequency division multiplexing (OFDM) waveform. However, these waveforms, when transmitted through a doubly dispersive wireless channel, can cause inter-symbol and inter-Doppler interference. This interference can result in cross-interference between the data-bearing quadrature amplitude modulation (QAM) symbols, leading to higher error rates at reception.

In this invention, we transmit fewer QAM symbols in a frame than the number of available grid points using OTFS, OTSM, and single carrier waveforms. This is achieved by sparsely loading the QAM symbols onto the grid. We ensure a sufficient distance between the QAM symbols across both dimensions of the two-dimensional grid in OTFS, OFDM, and OTSM, and only in the delay dimension in single carrier. Empty grid points are loaded with zero symbols, a method we refer to as partial loading. This approach results in several dB signal to noise ratio (SNR) advantages in error performance and ensures high reliability at reception.

### System Model:

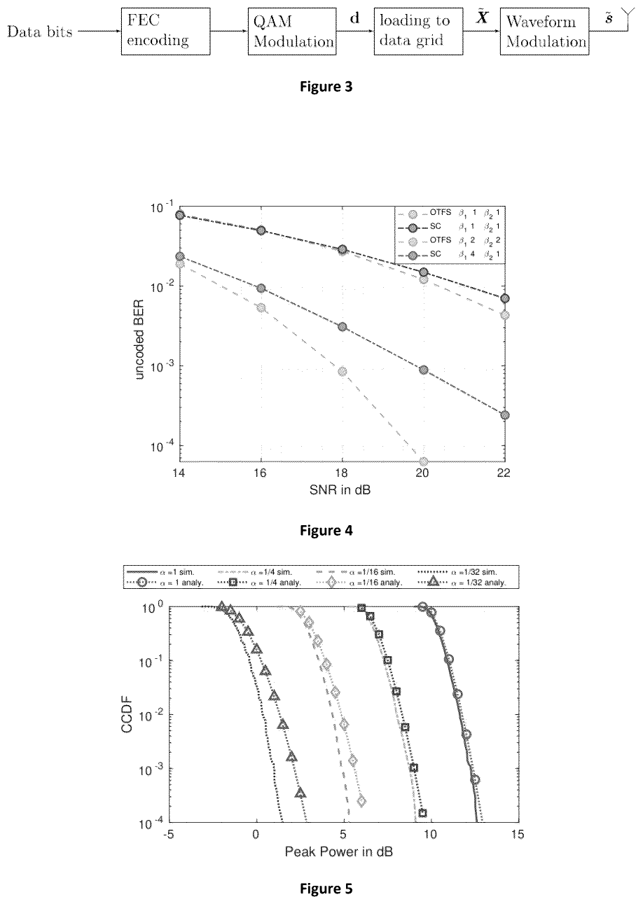

A block based schematic representation of the system is shown in the FIG. 3. In this transmission block for brevity D/A conversion after waveform modulation and RF chain before antenna are omitted.

The data bits or channel-coded bits are modulated using Quadrature Amplitude Modulation (QAM) or Phase Shift Keying (PSK) modulation of order ‘M’ For simplicity, modulation as QAM is referred, but the invention also applies to PSK. In each frame, a resource grid of size M×N is used to load QAM symbols onto the grid points. The M*N QAM symbols are arranged into an M×N matrix X, which matches the dimensions of the resource grid. The row-column position of each QAM symbol in X represents a grid point in the signaling domain. This can be delay-Doppler (de-Do) for OTFS, time-frequency (TF) for OFDM, delay-sequency for OTSM, and delay-time for SC transmission. For a system bandwidth of B, the delay bin resolution (Δτ), Doppler bin resolution (Δv), time symbol duration (T), and subcarrier spacing (Δf) are related to each other as,

$$Δτ = \frac{1}{B} , Δ v = \frac{1}{MN Δτ} , T = M Δτ , Δ f = \frac{1}{T} . \qquad ( 1 )$$

TABLE 2
description of P and Q in (2) for different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

$${F}_{N}^{H}$$

is an Inverse Discrete Fourier Transform (IDFT) matric of order N. W_{N} is a Walsh Hadamard Transform (WHT) matrix of order N. I_{N} is an identity matrix of order N.

The signal generation with the data symbols present in X, for the waveforms OTFS, OFDM, OTSM, and single carrier can be expressed in an unified manner using matrices Q and P listed in Table 2 as

$$s = vec ( Q \times P ) , \qquad ( 2 )$$

$$= ( P ⊗ Q ) x , \qquad ( 3 )$$

Where

$$s = {\{ s [ n ] \}}_{n = 0}^{MN - 1}$$

is a discrete time signal, x∈ [symbol] ^{MN×1}=vec(X). A single cyclic prefix (CP) of length I_{cp} sufficient to accommodate channel delay spread is included to s before transmission.

### Partial Loading

In the partial loading, only a I<M N number of QAM symbols are transmitted instead of the full (M N) number of symbols. The I and M N are related by α which is a factor for partial loading as

$$I = α MN \qquad ( 4 )$$

The parameter α ranges between 0 and 1, and its value is determined by the level of reliability required for a given application. Higher reliability corresponds to a lower error probability. Therefore, a should be chosen to be small when a very low error probability (or high reliability) is necessary. Additionally, the selection of a impacts the overall data rate, as a lower α reduces the data rate. Consequently, the choice of α must balance the specific reliability and data rate requirements of the application. Lets denote d=[d[0], d[1], . . . , d[i], . . . , d[I−1]]^{T} as the symbol vector for transmission in partial loading. These symbols are sparsely loaded into an M×N matrix X^{˜} in a systematic form with distance of β₁ between two consecutive symbols along row dimension and distance β₂ along the columns. Zero symbols are filled in other positions of X^{˜}. Assuming M and N are divisible by β₁ and β₂ respectively, then β₁ and β₂ are related to a by the equation

$${β}_{1} {β}_{2} = \frac{1}{α}$$

In instances where M and N are not divisible by β₁ and β₂ respectively, a reduced grid M_{new}×N_{new} will instead be used for loading. Here, M_{new}≤M and is divisible by β₁ and N_{new}≤N and is divisible by β₂.

FIG. 1 shows a sparsely loaded symbol matrix for M=8 and N=8 with β₁ being 2 and β₂ being 4.

$$The elements x ( l , k ) of X for l = 0 , 1 , … , M - 1 and k = 0 , 1 , … , N - 1 is expressed as \tilde{x} ( l , k ) = \{ \begin{matrix}d [ j ] & if l = ( i ) \text{?} {β}_{i} and k = \text{?} \\ 0 & Otherwise\end{matrix} \qquad ( 6 )$$

$$\text{?} \text{indicates text missing or illegible when filed}$$

From (3), the transmitting signal with partial loading is

$$\tilde{s} = ( P ⊗ Q ) \hat{x} . \qquad ( 7 )$$

where \hat{x}=vec(\dot{X}). The \hat{x} can also be expressed in terms of an MN×I matrix J and d as

$$\tilde{x} = Jd . \qquad ( 8 )$$

The elements j(n,i) of J, for n=0, 1, . . . , MN−1 and i=0, 1, . . . , I−1, are given as

$$j ( n , i ) = \{ \begin{matrix}1 & if n = ( i ) \text{?} {β}_{i} + ⌊ \frac{\text{?}}{M} ⌋ {β}_{2} M \\ 0 & Otherwise .\end{matrix} \qquad ( 9 )$$

$$\text{?} \text{indicates text missing or illegible when filed}$$

From equation (9), since the J matrix is non-square and its column vectors are orthogonal to each other, it satisfies the semi-orthogonality condition as

$${J}^{T} J = {I}_{l} . \qquad ( 10 )$$

For OTFS and OTSM, increasing the β₁ and β₂ can enhance the error performance, as these waveforms resolve both the delays and Dopplers of the wireless channel. However, since a single carrier resolves only the delays of the wireless channel, the advantage of partial loading can be obtained only by varying β₁ and keeping β₂ as unity, as depicted in FIG. 2.

The signal, after removal of the CP and transformation to the signaling domain, is expressed as:

$$\tilde{y} = H \tilde{x} + w , \qquad ( 11 )$$

Here, H is the channel matrix in the transforming domain with a size of MN×MN, and w is the AWGN noise in the transforming domain. Using eq. (8), we can rewrite eq. (11) as:

$$\tilde{y} = H J d + w . \qquad ( 12 )$$

The estimate of d is then obtained by performing MMSE equalization as

$$\tilde{d} = {G}^{H} \tilde{y} , \qquad ( 13 )$$

$$= {G}^{H} HJd + {G}^{H} w \qquad ( 14 )$$

$$where G ∈ {ℂ}^{MN \times 1}$$

$$G = ( HJ ) {( {( HJ )}^{H} ( HJ ) + {σ}^{2} {I}_{I} )}^{- 1} . \qquad ( 15 )$$

We see that the order of the matrix under inversion in (15) is I which is the number of symbols being transmitted. Thus, the complexity of the receiver is influenced by the number of transmitted symbols; the fewer the symbols transmitted, the lower the receiver complexity.

FIG. 4 shows the uncoded bit error rate (BER) with both partial and full loading in OTFS and single carrier for the 3GPP channel model 3D UMANLOS and 16-QAM modulation. The grid parameters are M=512 and N=16. For full load, the distance parameters are β₁₌₁ and β₂=1. OTFS's partial loading is evaluated with β₁₌₂ and β₂=2, while for the single carrier, β₁=4 and β₂=1 are considered. In both partial loading scenarios, the loading factor α=¼. Both the single carrier and OTFS benefit from partial loading, providing an SNR gain of nearly 4.5 dB at a BER of 10⁻². Additionally, OTFS provides an extra 0.5 dB SNR gain compared to the single carrier.

Peak Power Distributions for the Transmitted Waveform with Partial Loading

The single carrier waveform exhibits excellent peak to average power (PAPR) characteristics because no transform is needed and the data QAM symbols are transmitted directly. However, in OTFS and OTSM, since the data QAM symbols exist in the delay-Doppler and delay-sequency domain, to generate a time domain waveform for these symbols, transforms such as inverse ZAK or IDSFT are applied. These transforms can produce large peaks in the time domain, causing the High Power Amplifiers (HPAs) at the transmitter to saturate and introduce non-linear distortions. This can result in increased error rates and reduced overall I communication reliability.

However, partial loading for OTFS and OTSM can mitigate this by reducing peak power compared to the full load case. This is due to the insertion of zeros between the QAM symbols in the delay Doppler grid or delay-sequency grid. The peak power distribution for OTFS with partial loading can be predicted as follows.

For a large N, the N point IDFT sequence can be assumed to be a complex Gaussian random variable due to the Central Limit Theorem. Its magnitude follows a Rayleigh random variable. Each OTFS frame contains M IDFT sequences, each of length N. As a result, the Complementary Cumulative Distribution Function (CCDF) of the OTFS signal at a peak value xₘₐₓ is as follows:

$$Prob \{ \vert s \vert >= {x}_{max} \} = 1 - {( {( 1 - {e}^{- \frac{{z}_{ma x}^{2}}{{σ}_{s}^{2}}} )}^{N} )}^{M} , \qquad ( 16 )$$

where σₛ² is the power of each IDFT sample, which is unity with a normalized IDFT operation for full loading. Under partial loading, only M/β₁ IDFT sequences will be present and the input QAM symbols for IDFT are separated with distance β₂ and zeros are stuffed between them. Therefore, the IDFT sequence is periodic with a period of β₂ while σₛ² is reduced to 1/β₂. This leads us to rewrite (16) for OTFS with partial loading as

$$Prob \{ \vert s \vert >= {x}_{max} \} = 1 - {( {( 1 - {e}^{- \text{?}} )}^{\text{?}} )}^{\text{?}} , \qquad ( 17 )$$

$$\text{?} \text{indicates text missing or illegible when filed}$$

FIG. 5 presents the peak power CDF for OTFS with a grid of M×N=512×64 under varying partial loading factors α. The β₁ and β₂ selected for each a are listed in Table 3. The figure demonstrates that as the α decreases, both the simulation and the analytical expression (given in eq. (17)) show a decrease in the peak power of the transmitted waveform. Additionally, the discrepancy between the anticipated peak power distribution and the simulation increases as the partial loading factor α decreases. This discrepancy occurs due to the insertion of zeros, which reduces the period of the IDFT sequence and causes the amplitude distribution to deviate from the Gaussian.

TABLE 3
Partial loading factor and corresponding values of β₁ and β₂

| α | 1 | ¼ | 1/16 | 1/32 |
|---|---|---|---|---|
| β₁ | 1 | 2 | 4 | 4 |
| β₂ | 1 | 2 | 4 | 8 |

The present invention could improve the reliability of reception for high sensitivity and emergency applications in wireless communication by providing a transmission mechanism. It also lowers the peak power requirement for high-power amplifiers (HPA) in the transmitter. This allows internet of things (IoT) reduced capability devices to be used in cases that require high reliability. It uses orthogonal time frequency space (OTFS), orthogonal time sequence multiplexing (OTSM), and single carrier waveforms for transmission. These provide higher channel diversity than the orthogonal frequency division multiplexing (OFDM) waveform. However, these waveforms, when transmitted through a doubly dispersive wireless channel, can cause inter-symbol and inter-Doppler interference. This interference can result in cross-interference between the data-bearing quadrature amplitude modulation (QAM) symbols, leading to higher error rates at reception.

In the present invention, fewer QAM symbols are transmitted in a frame as compared to the number of available grid points using OTFS, OTSM, OFDM and single carrier waveforms. This is achieved by sparsely loading the QAM symbols onto the grid. A sufficient distance between the QAM symbols is ensured across both dimensions of the two-dimensional grid in OTFS, OTSM and OFDM, and only in the delay dimension in single carrier. Empty grid points are loaded with zero symbols, a method we refer to as partial loading. This approach results in several dB signal to noise ratio (SNR) advantages in error performance and ensures high reliability at reception.

Thus, according to an aspect of the present invention there is provided said wireless communication system suitable for high sensitivity and emergency applications in wireless communication embedded with transmission mechanistic analytics to improve reliability of transmission and peak power by reducing cross interference between data symbols caused by doubly dispersive wireless channels.

According to yet another aspect of the present invention there is provided said wireless communication system with embedded transmission mechanism/analytics that involve transmitting fewer data symbols as compared to the available grid points.

According to another preferred aspect of the present invention there is provided said wireless communication system with embedded transmission mechanism/analytics that transmits fewer data symbols to the data grid where the grid refers to a two-dimensional resource or data grid, characterized by a delay dimension and a Doppler dimension in OTFS delay and Sequency for OTSM, and delay-time for single carrier systems.

Preferably said grid includes virtual grid and formed from the available resource elements for transmission in OFDM-based systems.

Preferably in said system and method thereof a limited number of data symbols are sparsely loaded onto a larger resource data grid, with QAM symbols separated by a distance of β₁ symbols along the delay dimension and/or across the Doppler dimension for OTFS and the Sequency dimension for OTSM with a distance of β₂ symbols. In single carrier systems, the symbols are separated only along the delay dimension by a distance of β₁ symbols while β₂=1. Zero symbols are loaded in the other points of the grid.

Preferably selection of parameters β₁ and β₂ is important, and β₁ should be so chosen to sufficiently accommodate the delay spread of the channel, and β₂ should be chosen to sufficiently accommodate the Doppler spread of the channel. Alternatively, they can be optionally chosen in the range of 1 to M−1 for β₁ and 1 to N−1 for β₂ respectively.

More preferably, said selected values for β₁ and β₂ if the grid parameters M and/or N are not divisible by β₁ and/or β₂ respectively, a reduced grid M_{new}≤M and N_{new}≤N will be considered, for which β₁ and β₂ divide M_{new} and N_{new}, respectively. Zero symbols are loaded for the points between M_{new} and M and N_{new} and N.

Advantageously sparsely loaded symbols on the resource grid are transmitted using waveform modulation, such as inverse ZAK transform for OTFS or inverse discrete symplectic Fourier transform (IDSFT) or their alternative forms, followed by OFDM modulation. Instead of using inverse discrete Fourier transform operation in inverse ZAK and IDSFT or their alternatives, the Walsh-Hadamard transform is used to transmit sparsely loaded data symbols on the resource grid for OTSM. In single carrier, the loaded data symbols and zero symbols on the resource grid are directly transmitted serially, column by column.

In said system the total grid points receives transmitted data and only those grid points are selected for demodulation which were considered for loading in the transmission with the use of the precoding matrix used at the transmission side. The system is adapted to find end use and application preferably in 6G for ultra-reliable and low latency communication (uRLLC) applications, communication from low-power and low-cost internet of things (IoT) devices.

1. A wireless communication system for enhanced reliability of wireless communication and reducing peak power in wireless data transmission across different waveforms comprising
transmitter modules coupled to waveform modulators including waveform two-dimensional resource or data grids representative of a signal processing domain for transmitting data bit bearing symbols across varied waveforms under controlled sparsely/partially loading of fewer modulated data symbols of the available grid points of a larger two-dimensional resource or data grid for transmission as spaced fewer data symbols with loading zero symbols at remaining empty grid points,
said modulated data symbols under controlled sparsely/partially loading including said fewer modulated data symbols being allocated in the resource or data grid and distanced there between based on a factor for partial loading and full number of symbols accommodable in the resource or data grid to reduce cross interference amongst symbols and minimize error rate;
cooperative receiver module corresponding to receive all loaded grid points and including demodulator to selectively demodulate only those select grid points carrying said fewer modulated data symbols loaded during transmission by said transmitter module, thereby enabling reliable data transmission with several dB signal to noise ratio advantage free of any need of Channel State Information (CSI) analytics at the transmitter.

2. The system as claimed in claim 1 wherein said transmitter module bear processor domains that include data symbol based signal generating domain, the two dimensional resource or data grid formation domain, modulated signal waveform based sparse symbol loading domain for loading transformed signal, transformed signal signaling domain;
said waveform modulators are based on Quadrature Amplitude Modulation (QAM) or Phase Shift Keying (PSK) modulation of order ‘M’ for transmitting and loading said QAM based symbols or PSK symbols onto said resource or data grid.

3. The system as claimed in claim 1, wherein said data grid includes a processor for creating virtual two dimensional data grid from available resource elements for transmitting OFDM (orthogonal frequency division multiplexing) waveforms while integrating the partial load method with existing OFDM-based systems or creating a straightforward two dimensional data grid of resource elements, said data grid being characterized by a delay dimension and a Doppler dimension for processing OTFS (orthogonal time frequency space) waveform, delay and Sequency for OTSM (orthogonal time sequence multiplexing) waveform, and delay-time for single carrier (SC) waveforms.

4. The system as claimed in claim 3, wherein said resource grid includes size M×N for accommodating the full MN number of symbols the resource or data grid being arranged into an M×N matrix X, which matrix X matches the dimensions of the resource grid with the row-column position of each QAM symbol in X representing a grid point in the signaling domain including delay-Doppler (de-Do) for OTFS, time-frequency (TF) for OFDM, delay-sequency for OTSM, and delay-time for SC transmission.

5. The system as claimed in claim 1, for transmission at bandwidth B the delay bin resolution (Δτ), Doppler bin resolution (Δv), time symbol duration (T), and subcarrier spacing (Δf) are related to each other as,
$$Δ τ = \frac{1}{B} , Δ v = \frac{1}{MN Δτ} , T = M Δ τ , Δ f = \frac{1}{T} , \qquad ( 1 )$$
wherein signal generation with the data symbols present in matrix X, for the waveforms OTFS, OFDM, OTSM, and single carrier (SC) is computed in an unified manner using matrices Q and P listed in below Table for said different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

where
$${F}_{N}^{H}$$
is an Inverse Discrete Fourier Transform (IDFT) matrix of order N, W_{N} is a Walsh Hadamard Transform (WHT) matrix of order N, and I_{N} is an identity matrix of order N, and
which signal generation with the data symbols present in matrix X unified under said P and Q matrices for straightforward two-dimensional data grid are computed as
$$s = vec ( QXP ) , \qquad ( 2 )$$
$$= ( P ⊗ Q ) x , \qquad ( 3 )$$
where
$$s = {\{ s [ n ] \}}_{n = 0}^{MN - 1}$$
is a discrete time signal, x∈ [symbol] ^{MN×1}=vec(X) and a single cyclic prefix (CP) of length I_{cp} is sufficient to accommodate channel delay spread that is included in s before transmission.

6. The system as claimed in claim 1, wherein the transmitter module partially load only I<M N number of QAM symbols of full (M N) number of accommodable symbols whereby I and M N are related by the partial loading fact ‘α’ which is being computed by the transmitter module as
$$I = α M N \qquad ( 4 )$$
and if d=[d[0], d[1], . . . , d[i], . . . , d[I−1]]^{T} is denoted as symbol vectors for transmission based on their partially/sparsely loading onto M×N type matrix named as X^{˜} partially loaded matrix with the vectors loaded therein in a systematic form with distance β₁ maintained between two consecutive symbols along row dimension and distance β₂ maintained along the columns with Zero symbols being filled in other positions of said X^{˜} matrix.

7. The system as claimed in claim 6, wherein in said sparsely loaded X^{˜} matrix when M and N are divisible by β₁ and β₂ respectively, then β₁ and β₂ are related to ‘α’ by the equation
$${β}_{1} {β}_{2} = \frac{1}{α} \qquad ( 5 )$$

8. The system as claimed in claim 7, wherein in said sparsely loaded X″ matrix where M and N are not divisible by β₁ and β₂ respectively, a reduced grid M_{new}×N_{new} is instead involved for loading symbols where M_{new}≤M becomes divisible by β₁ and N_{new}≤N becomes divisible by β₂, such that for sparsely loaded symbol matrix for transmission of M=8 and N=8, β₁ is 2 and β₂ is 4, and elements x\tilde(l, k) of X\tilde for l=0, 1, . . . , M−1 and k=0, 1, . . . , N−1 is expressed as
$$\tilde{x} ( l , k ) = \{ \begin{matrix}d [ i ] & if l = {( i )}_{\frac{μ}{{β}_{1}}} {β}_{1} and k = ⌊ \frac{i {β}_{1}}{M} ⌋ {β}_{2} \\ 0 & Otherwise\end{matrix} \qquad ( 6 )$$

9. The system as claimed in claim 8, wherein corresponding to said signal generation with said data symbols present in matrix X unified under said P and Q matrices for different waveforms and computed as in Eq. (3),
the corresponding transmitting signal with partial loading is expressed as
$$\tilde{s} = ( P ⊗ Q ) \tilde{x} , \qquad ( 7 )$$
where x^{˜}=vec(X^{˜}) said x^{˜} is also computed in terms of MN×I matrix J and d represented as
$$\tilde{x} = Jd . \qquad ( 8 )$$
where the elements j(n, i) of J, for n=0, 1, . . . , MN−1 and i=0, 1, . . . , I−1, are given as
$$j ( n , i ) = \{ \begin{matrix}1 & if n = {( i )}_{\frac{μ}{{β}_{1}}} {β}_{1} + ⌊ \frac{i {β}_{1}}{M} ⌋ {β}_{2} M \\ 0 & Otherwise .\end{matrix} \qquad ( 9 )$$
wherein from equation (9), since J matrix is non-square and its column vectors are orthogonal to each other, it satisfies the semi-orthogonality condition as per the following computational relation
$${J}^{T} J = {I}_{I} . \qquad ( 10 )$$

10. The system as claimed in claim 5, wherein said partially loaded matrix based transmitting signal after removal of said cyclic prefix (CP) and transformation to the signaling domain is computed as
$$\tilde{y} = H \overline{x} + w , \qquad ( 11 )$$
where H is the channel matrix in transforming domain with a size of MN×MN, and w is the AWGN noise in the transforming domain whereby computing in relation to said eq. (8) the computation under Eq. (11) is re-computed to
$$\tilde{y} = HJd + w . \qquad ( 12 )$$
where estimate of ‘d’ is then obtained by performing MMSE equalization as:
$$\hat{d} = {G}^{H} \tilde{y} , \qquad ( 13 )$$
$$= {G}^{H} HJd + {G}^{H} w \qquad ( 14 )$$
where G∈C^{MN×I}
$$G = ( HJ ) {( {( HJ )}^{H} ( HJ ) + {σ}^{2} {I}_{I} )}^{- 1} . \qquad ( 15 )$$
whereby order of matrix under inversion in computation (15) is I which is the number of symbols being transmitted for receiving by said cooperative receiver module.

11. The system as claimed in claim 4, wherein uncoded bit error rate (BER) comparison with different β₁ and β₂ for OTFS and single carrier (SC) based on the present transmission system provides in 3GPP channel signal propagation under grid parameters of M=512 and N=16 which in consideration of full load having distance parameters β₁=1 and β₂=1, and for OTFS's partial loading under distance parameters β₁=2 and β₂=2, while for single carrier (SC) propagation having β₁₌₄ and β₂=1, whereby in both said partial loading scenarios loading factor α=¼ both said single carrier (SC) and OTFS benefit from partial loading providing an SNR (signal-to-noise ratio) gain of nearly 4.5 dB at a BER of 10⁻² with OTFS provides an extra 0.5 dB SNR gain compared to the single carrier (SC).

12. The system as claimed in claim 10 wherein for said sparsely loading limited number of data symbols onto a larger resource grid, said QAM symbols are separated by a distance of β₁ symbols along the delay dimension and/or across the Doppler dimension for OTFS and the Sequency dimension for OTSM with a distance of β₂ symbol, and wherein in single carrier (SC) based waveforms symbols are separated only along the delay dimension by a distance of β₁ symbols while β₂=1 and zero symbols are loaded in the other points of the grid.

13. The system as claimed in claim 6, wherein distance parameters β₁ and β₂ are so selected to sufficiently accommodate the delay spread of the wireless communicative channels, and β₂ is selected to sufficiently accommodate the Doppler spread of the channels, and alternatively in the range of 1 to M−1 for β₁ and 1 to N−1 for β₂ respectively.

14. The system as claimed in claim 13, wherein for selected values for β₁ and β₂ if the grid parameters M and/or N are not divisible by β₁ and/or β₂ respectively, a reduced grid M_{new}≤M and N_{new}≤N are processed, for which β₁ and β₂ divide M_{new} and N_{new}, respectively and Zero symbols are loaded for the points between M_{new} and M and N_{new} and N.

15. The system as claimed in claim 10, wherein sparsely loaded symbols on the resource grid are transmitted based on modulation by said waveform modulators that processes by computing through inverse ZAK transform for OTFS or inverse discrete symplectic Fourier transform (IDSFT) or their alternative forms, followed by OFDM modulation.

16. The system as claimed in claim 1, wherein said waveform modulators instead of processing by inverse discrete Fourier transform operation in inverse ZAK and IDSFT for the virtual data grid or their alternatives, the Walsh-Hadamard transform is operation is involved to transmit sparsely loaded data symbols on the resource grid for OTSM.

17. The system as claimed in claim 1, wherein for single carrier waveform (SC), the loaded data symbols and zero symbols on the resource grid are directly transmitted serially, column by column.

18. The system as claimed in claim 1, wherein peak power of the transmitted waveform can be reduced and help minimize the nonlinear effects of high power amplifiers for suitable end applications in 6G applications for ultra-reliable and low latency communication (uRLLC) applications including communications from low-power and low-cost internet of things (IoT) devices.

19. A method for wireless communication with enhanced reliability and reducing peak power in wireless data transmission across different waveforms comprising
modulating transmitting data bit bearing symbols across varied waveforms to produce modulated data symbols by waveform modulators;
sparsely/partially loading the modulated data symbols in available grid points of a larger two dimensional resource or data grid for transmission by transmitter module;
fixing selective distances between the modulated data symbols while allocating in the resource or data grid based on a factor for partial loading and full number of symbols accommodable in the resource or data grid to reduce cross interference amongst symbols and minimize error rate; and
loading zero symbols at remaining empty grid points.

20. The method as claimed in claim 19, wherein the waveform modulators are based on Quadrature Amplitude Modulation (QAM) or Phase Shift Keying (PSK) modulation.

21. The method as claimed in claim 19 fixing selective distances between the modulated data symbols while allocating in the resource or data grid includes
involving said resource grid includes size M×N for accommodating full MN number of symbols in the resource or data grid arranged into an M×N matrix X;
partially loading I number of points of the full (M N) number of accommodable symbols with modulated symbols where whereby I and M N are related by the partial loading factor ‘α’ as I=αM N;
miniating a distance β₁ between two consecutive loaded symbols along row dimension and a distance β₂ along columns with zero symbols being filled in other points, whereby the β₁ and β₂ are related to ‘α’ as β₁·β₂=1/α when M and N are divisible by β₁ and β₂ respectively and M and N are not divisible by β₁ and β₂ respectively, a reduced grid M_{new}×N_{new} is involved for loading symbols where M_{new}≤M becomes divisible by 31 and N_{new}≤N becomes divisible by β₂.

22. The method as claimed in claim 21, wherein parameters β₁ and β₂ are so selected to sufficiently accommodate the delay spread of the wireless communicative channels, and β₂ is selected to sufficiently accommodate the Doppler spread of the channels, and alternatively in the range of 1 to M−1 for β₁ and 1 to N−1 for β₂ respectively.
